(19) United States
(12) Patent Application Publication
(10) Pub. No.: US 2018/0089172 A1
(43) Pub. Date: Mar. 29, 2018

(54) COMMUNICATION SYSTEM SUPPORTING BLENDED-LANGUAGE MESSAGES

(71) Applicant: Intel Corporation, Santa Clara, CA (US)

(72) Inventor: Bradford H. Needham, North Plains, OR (US)

(73) Assignee: Intel Corporation, Santa Clara, CA (US)

(21) Appl. No.: 15/277,145

(22) Filed: Sep. 27, 2016

(51) Int. Cl. G06F 17/28; H04L 29/08; H04L 12/58; G06F 17/27

(52) U.S. Cl. CPC G06F 17/289; H04L 67/306; H04L 67/02; G06F 17/2785; H04L 51/04

(57) ABSTRACT

A mixed-language translator apparatus may include a language estimator to estimate two or more languages of at least two message fragments in an electronic representation of a mixed-language message including at least two languages, a language preference detector to determine a language preference of an intended recipient for the mixed-language message, and a translator communicatively coupled to language estimator and the language preference detector to translate the mixed-language message based on the estimated two or more languages of the at least two message fragments and the language preference of the intended recipient. Other embodiments are disclosed and claimed.

### TECHNICAL FIELD

Embodiments generally relate to multilingual communications. More particularly, embodiments relate to a system, apparatus, and method for mixed-language communications.

### BACKGROUND

An article entitled “Automatic Translation in Multilingual Electronic Meetings,” by Milam Aiken, et al., published July 2009 in TRANSLATION JOURNAL, VOLUME 13, NO. 3, describes software called POLYGLOT to support an automated multilingual meeting system. A source single language message can be automatically translated into multiple target languages for different meeting attendees. According to the article, U.S. Pat. No. 5,966,685 describes a system which allows for an electronic discussion group user to communicate with another user who speaks a different language. Machine translators and other software are incorporated to translate messages, thereby creating parallel discussion groups in different languages. According to the article, U.S. Pat. No. 5,987,401 describes a real-time language translation technique for text-based conversations. The messages forming the text-based conversation amongst a plurality of participants to the conversation are translated in real-time either from a user language to a conversation language of the conversation, or from the conversation language to the user language.

U.S. Pat. No. 5,784,568 describes a method of communicating among participants at participant stations 1-N, where the participant stations 1-N are connected to a data communications network. A number of audio packet queues 1-N are assigned to each participant station 1-N. A composite audio packet is sent over the data communications network to each of the stations. The composite audio packet is comprised of an audio packet and a sending station identification (ID), the sending station ID corresponding to the station at which the composite packet originates. When the talking is done, a composite end-of-utterance marker packet is sent over the data communications network to each station. The composite end-of-utterance marker packet is comprised of an end-of-utterance marker and the sending station ID. At a receiving station, the audio packet corresponding to the sending station at which the composite packet originates is placed in an audio packet queue allocated to that sending station. The receiving station detects the composite end-of-utterance marker packet, at which time the contents of the audio packet queue are moved to a ready-to-play queue. The audio packets are played back from the ready-to-play queue.

U.S. Pat. No. 5,889,764 describes a method where a plurality of transmissions are received by a receiving node, with each transmission representing an utterance of audio information. Each transmission is transmitted from a different one of the transmitting nodes and includes a number of audio data packets. One of the utterances is designated as a ready-to-play utterance based on an order in which the utterances were received. The data packets of any utterance designated as the ready-to-play utterance are provided to a ready-to-play queue in real time. Data packets of the other utterances are held in separate queues and are not provided to the ready-to-play queue until after the packets of the ready-to-play utterance have been provided to the ready-to-play queue. After the data packets of the ready-to-play utterance have been provided to the ready-to-play queue, a new utterance is designated as the ready-to-play utterance.

U.S. Pat. No. 5,062,143 describes a mechanism for examining a body of text and identifying its language which compares successive trigrams into which the body of text is parsed with a library of sets of trigrams. For a respective language-specific key set of trigrams, if the ratio of the number of trigrams in the text, for which a match in the key set has been found, to the total number of trigrams in the text is at least equal to a prescribed value, then the text is identified as being possibly written in the language associated with that respective key set. Each respective trigram key set is associated with a respectively different language and contains those trigrams that have been predetermined to occur at a frequency that is at least equal to a prescribed frequency of occurrence of trigrams for that respective language. Successive key sets for other languages are processed as above, and the language for which the percentage of matches is greatest, and for which the percentage exceeded the prescribed value as above, is selected as the language in which the body of text is written.

Numerous academic and technical articles describe identifying the language of text in a document. An article by Cavnar et al., entitled “N-gram based text categorization,” was published in Proceedings of the Third Symposium on Document Analysis and Information Retrieval, Las Vegas, U.S.A (1994). An article by Ahmed et al., entitled “Detection of Foreign Entities in Native Text Using N-gram Based Cumulative Frequency Addition,” was published in Proceedings Student/Faculty Research Day, CSIS, Pace University (2005). An article by Lui et al., entitled “Cross-domain Feature Selection for Language Identification,” was published in Proceedings of the 5th International Joint Conference on Natural Language Processing, pages 553-561, Chiang Mai, Thailand (2011).

Commercially available software supports language identification. A PYTHON programming language tool, langid.py is a standalone Language Identification (LangID) tool. The langid.py tool is designed to be fast, pre-trained over a large number of languages, not sensitive to domain-specific features (e.g. HTML/XML markup), a single .py file with minimal dependencies, and deployable as a web service.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a mixed-language communication system according to an embodiment;

FIG. 2 is a block diagram of an example of a mixed-language translator according to an embodiment;

FIGS. 3A to 3C are flowcharts of an example of a method of mixed-language translation according to an embodiment;

FIG. 4 is a diagram of another example of a mixed-language communication system according to an embodiment; and

FIG. 5 is an example of a table illustration of a language preference database according to an embodiment.

### DESCRIPTION OF EMBODIMENTS

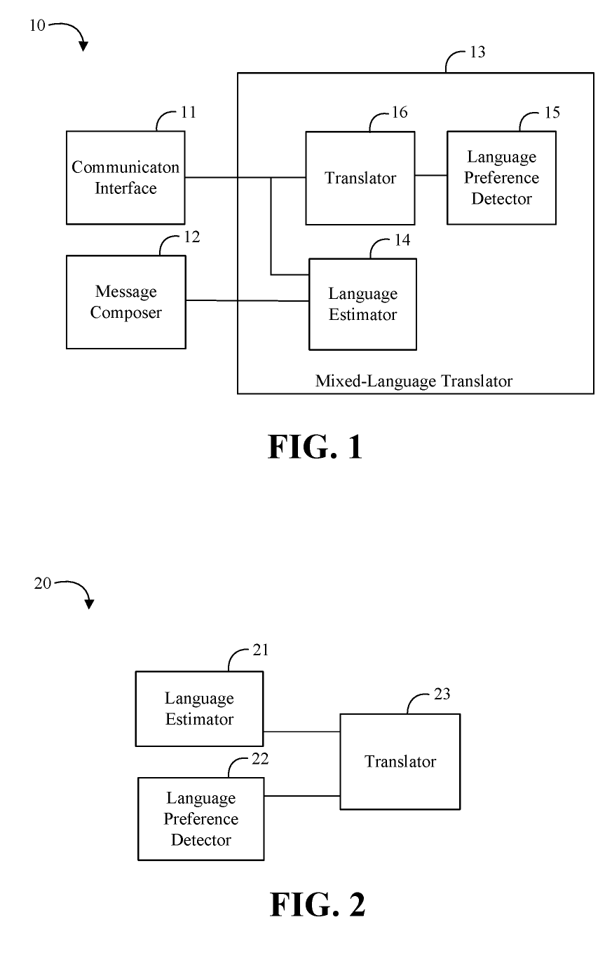

Turning now to FIG. 1, an embodiment of a mixed-language communication system 10 may include a communication interface 11 to send and receive electronic representations of messages between at least two users, a message composer 12 to compose an electronic representation of a message, including a mixed-language message including a mix of at least two languages, and a mixed-language translator 13 communicatively coupled to the communication interface 11 and the message composer 12. An embodiment of the mixed-language translator 13 may include a language estimator 14 to estimate two or more languages of at least two message fragments in one or more of a received mixed-language message from the communication interface 11 or a composed mixed-language message from the message composer 12, a language preference detector 15 to determine a language preference of one or more intended recipients, and a translator 16 communicatively coupled to the language estimator 14 and the language preference detector 15 to translate one or more of the composed mixed-language message from the message composer 12 or the received mixed-language message from the communication interface 11 based on the estimated two or more languages of the at least two message fragments and the language preference of the one or more intended recipients. For example, the messages may be text-based messages or digitized speech messages.

In some embodiments of the mixed-language communication system 10, the language preference detector 15 may be further configured to determine a language preference of a composer of the composed mixed-language message, and the language estimator 14 may be further configured to estimate the two or more languages of the at least two message fragments in one or more of the composed message or the received message based on one or more of the language preference of the composer or the language preference of the one or more intended recipients. In some embodiments of the mixed-language communication system 10, the language preference detector 15 may be further configured to determine the language preference of the one or more intended recipients based on stored information including one or more of a pre-identified language preference associated with one or more of the composer or the one or more intended recipients, a prior communication, a local file analysis, or a location indicator.

Non-limiting examples of devices which may utilize the mixed-language communication system 10 include a computer, a laptop, a convertible computer, a tablet computer, a smartphone, a smart device, a gaming console, a wearable device, an internet-of-things (IoT) device, a kiosk, a chat system, an instant message system, a text message system, an automated voice response system, and any human interface device which includes voice or text input as part of its user interaction experience. Embodiments of each of the above communication interface 11, message composer 12, mixed-language translator 13, language estimator 14, language preference detector 15, translator 16, and other system components may be implemented in hardware, software, or any suitable combination thereof.

For example, hardware implementations may include configurable logic such as, for example, programmable logic arrays (PLAs), field programmable gate arrays (FPGAs), complex programmable logic devices (CPLDs), or in fixed-functionality logic hardware using circuit technology such as, for example, application specific integrated circuit (ASIC), complementary metal oxide semiconductor (CMOS) or transistor-transistor logic (TTL) technology, or any combination thereof Alternatively, or additionally, these components may be implemented in one or more modules as a set of logic instructions stored in a machine- or computer-readable storage medium such as random access memory (RAM), read only memory (ROM), programmable ROM (PROM), firmware, flash memory, etc., to be executed by a processor or computing device. For example, computer program code to carry out the operations of the components may be written in any combination of one or more operating system applicable/appropriate programming languages, including an object oriented programming language such as JAVA, SMALLTALK, C++ or the like and conventional procedural programming languages, such as the “C” programming language or similar programming languages.

Turning now to FIG. 2, a mixed-language translator apparatus 20 may include a language estimator 21 to estimate two or more languages of at least two message fragments in an electronic representation of a mixed-language message including at least two languages, a language preference detector 22 to determine a language preference of an intended recipient for the mixed-language message, and a translator 23 communicatively coupled to the language estimator 21 and the language preference detector 22 to translate the mixed-language message based on the estimated two or more languages of the at least two message fragments and the language preference of the intended recipient.

For example, the messages may be text-based messages or digitized speech messages. For example, a message fragment may correspond to a word, a phrase, a part of a sentence, or a sentence. A mixed-language message may include at least two message fragments where none of the words in one of the fragments are found in a dictionary of the language of the other fragment.

For example, the language estimator 21 may be further configured to estimate lingual boundaries in the mixed-language message. In some embodiments of the mixed-language translator apparatus 20, the language estimator 21 may be further configured to assign respective confidence levels to the estimated two or more languages of the at least two message fragments. For example, the language preference detector 22 may be further configured to determine a language preference of a composer of the mixed-language message and the language estimator 21 may be further configured to assign the respective confidence levels based at least in part on one or more of the language preference of the composer or the language preference of the intended recipient.

In some embodiments of the mixed-language translator apparatus 20, the language preference detector 22 may be further configured to determine the language preference of one or more of the intended recipient or the composer based on stored information including one or more of a pre-identified language preference associated with one or more of the composer or the intended recipient, a prior translation, a local file analysis, or a location indicator. In some embodiments of the mixed-language translator apparatus 20, the translator 23 may be further configured to translate the mixed-language message based at least in part on one or more of the assigned confidence levels, an idiomatic analysis, a semantic analysis, a contextual probability of an appropriate translation, or a language skill level of one or more of the composer or the intended recipient. The translator 23 may also be further configured to translate the mixed-language message based at least in part on a language preference database associated with the intended recipient which maps source original languages to target translation languages.

Embodiments of each of the above language estimator 21, language preference detector 22, translator 23, and other components of the mixed-language translator apparatus 20 may be implemented in hardware, software, or any combination thereof. For example, hardware implementations may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, these components may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more operating system applicable/appropriate programming languages, including an object oriented programming language such as JAVA, SMALLTALK, C++ or the like and conventional procedural programming languages, such as the “C” programming language or similar programming languages.

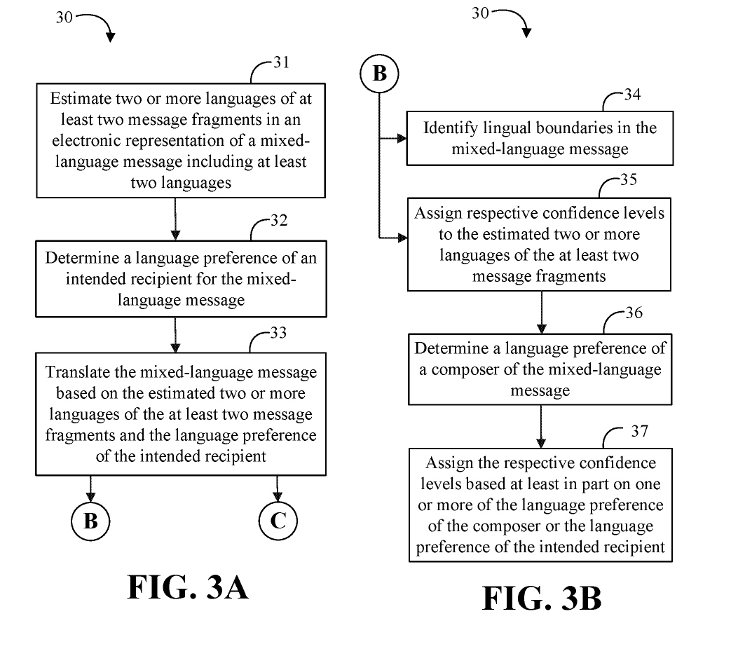

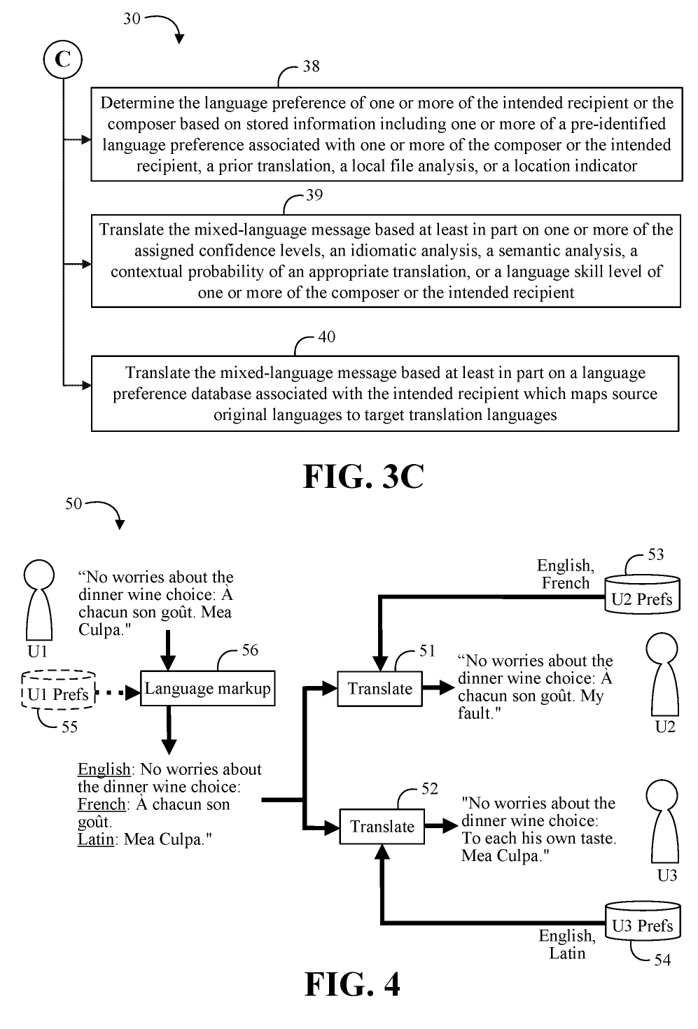

Turning now to FIGS. 3A to 3D, a method 30 of mixed-language translation may include estimating two or more languages of at least two message fragments in an electronic representation of a mixed-language message including at least two languages at block 31, determining a language preference of an intended recipient for the mixed-language message at block 32, and translating the mixed-language message based on the estimated two or more languages of the at least two message fragments and the language preference of the intended recipient at block 33. For example, the method 30 may further include identifying lingual boundaries in the mixed-language message at block 34.

Some embodiments of the method 30 may further include assigning respective confidence levels to the estimated two or more languages of the at least two message fragments at block 35. For example, the method 30 may further include determining a language preference of a composer of the mixed-language message at block 36, and assigning the respective confidence levels based at least in part on one or more of the language preference of the composer or the language preference of the intended recipient at block 37. The method 30 may further include determining the language preference of one or more of the intended recipient or the composer based on stored information including one or more of a pre-identified language preference associated with one or more of the composer or the intended recipient, a prior translation, a local file analysis, or a location indicator at block 38.

Some embodiments of the method 30 may further include translating the mixed-language message based at least in part on one or more of the assigned confidence levels, an idiomatic analysis, a semantic analysis, a contextual probability of an appropriate translation, or a language skill level of one or more of the composer or the intended recipient at block 39, and/or translating the mixed-language message based at least in part on a language preference database associated with the intended recipient which maps source original languages to target translation languages at block 40.

Embodiments of the method 30 may be implemented in a mixed-language communication system or mixed-language translator apparatus such as, for example, those described herein. More particularly, hardware implementations of the method 30 may include configurable logic such as, for example, PLAs, FPGAs, CPLDs, or in fixed-functionality logic hardware using circuit technology such as, for example, ASIC, CMOS, or TTL technology, or any combination thereof. Alternatively, or additionally, the method 30 may be implemented in one or more modules as a set of logic instructions stored in a machine- or computer-readable storage medium such as RAM, ROM, PROM, firmware, flash memory, etc., to be executed by a processor or computing device. For example, computer program code to carry out the operations of the components may be written in any combination of one or more operating system applicable/appropriate programming languages, including an object oriented programming language such as JAVA, SMALLTALK, C++ or the like and conventional procedural programming languages, such as the “C” programming language or similar programming languages. For example, the method 30 may be implemented on a computer readable medium as described in connection with Examples 18 to 24 below.

A conventional multilingual conversation system, such as POLYGLOT described above, may assume that a given writer or reader uses only one language during the conversation. However, multi-lingual people in conversation with other multi-lingual people often fluidly switch between two or more languages in the same message, depending on which language best expresses their meaning and mood at the moment. For example, a speaker of Spanish and English may text:
“Como esta! Let's get our grupo and go see the new Wes Anderson movie! Verdad?”
   Similarly, a speaker of English, French, and Latin may write:
“No worries about the dinner wine choice: À chacun son goût. Mea Culpa.”

Speakers, writers, listeners, and readers may be bilingual or multilingual, and may communicate with mixed-language speech or text messages. Some languages are inherently mixed such as creole languages. Even people who are predominantly monolingual may incorporate slang or non-native phrases in their conversations. A monolingual person participating in a group chat may find it difficult to follow a conversation that is sprinkled with phrases in a second or third language. Advantageously, some embodiments of a mixed-language communication system may provide a chat system that translates only the words and phrases from the language(s) that the user doesn't know, leaving the rest of the message unchanged.

Some embodiments of a mixed-language communication system may advantageously identify the language of individual words and phrases in a message rather than the whole message and, based on knowledge of the languages the user knows (e.g. speaks or reads), translate only the unknown words/phrases from unknown languages into known ones. Some embodiments of a mixed-language communication system may support both multi-lingual messages and multi-lingual users, to advantageously enable fluid communication with mixed-language conversations.

Turning now to FIG. 4, a mixed-language communication system 50 may support at least two people (e.g. a writer U1 and a reader U2, or a speaker and a listener). Three or more people (e.g. another reader U3) may typically be involved, because the writer is presumably writing to at least one reader that may be expected to understand the entire message without any translation. The mixed-language communication system 50 may enable text messages to be sent from the writer U1, through translation (e.g. translators 51, 52), to the readers U2 and U3. For example, the mixed-language communication system 50 may correspond to a multi-party chat system, where two people may share two languages, and a third may speak or read only one of the two languages.

Some embodiments of the system 50 may include language preference components 53, 54 that report the languages understood and preferred by the readers U2, U3. Optionally, a language preference component 55 may also report the languages that may be expressed by the writer U1. For example, each user may self-identify their language preferences and those pre-identified preferences may be stored (e.g. locally or on a cloud service) so that they can be retrieved as needed to guide the translators 51, 52. In addition, or alternatively, the language preference components 53, 54, 55 may estimate the language preferences of the users U1, U2, U3 by, for example, observing a history of their respective communications, reading other data (e.g. such as cultural or geographical context based on web page/search history data), or location service information (e.g. internet protocol (IP) address or global position satellite (GPS) information) to estimate preferred languages.

Some embodiments of the mixed-language communication system 50 may include a language estimator 56 to receive a message from the writer U1. For example, the language estimator 56 may identify lingual boundaries in the message. If the message is determined to include a mixed-language message, the language estimator 56 may insert language markup symbols which correspond to the estimated language of each message fragment. For example, the writer U1 may write:
“No worries about the dinner wine choice: À chacun son goût. Mea Culpa.”
   The language estimator 56 may compare the language in the message against various electronic language dictionaries to determine that the first portion of the first sentence is English, the second portion of the first sentence is French, and the second sentence is Latin. In addition, or alternatively, the language estimator 56 may utilize an n-gram or trigram technique to estimate an identification of the language of the text. In addition, or alternatively, the language estimator may use commercially available software (e.g. like the PYTHON langid.py library) or other well-known techniques to estimate the language of each word, phrase, or fragment. The language estimator 56 may then annotate by language the message with language markup symbols:
<English>No worries about the dinner wine choice:</English>
<French>À chacun son goût.</French>
<Latin>Mea Culpa.</Latin>
   For example, a suitable markup symbol may include hypertext markup language (HTML). International Organization for Standardization (ISO) 639-1 also defines abbreviations for languages. In HTML and XHTML the ISO 639-1 abbreviations can be used in the lang and xml:lang attributes.

From the language preference component 54, the translator 52 may determine that the reader U3 understands English and Latin, but not French, and prefers English. Based on that information, the translator 52 may produce:
“No worries about the dinner wine choice: To each his own taste. Mea Culpa.”
   On the other hand, if the language preference component 53 indicates that reader U2 understands English and French, but not Latin, the translator 51 may produce:
“No worries about the dinner wine choice: À chacun son goût. My fault.”

In some embodiments of the system 50, the language estimator 56 may estimate the language of each word or phrase in the message. Some estimates may represent the confidence or mix in the estimate (for example, such a system may consider “macho” an English and Spanish word, but “mi corazon” a solely Spanish phrase). The language estimator 56 may optionally adjust its estimates based on the language preferences of the writer U1 (e.g. expected languages based on the target translation preferences). For example, using the language preferences of the readers U2, U3, the translators 51, 52 may translate only the words or phrases from languages the reader doesn't read into the preferred language of the reader, leaving the remainder of the message unchanged. For example, in some embodiments of the system 50, the translators 51, 52 may comprehend the use of one language within another, to idiomatically translate in context. For the example of “Let's get our grupo and go see the new Wes Anderson movie!”, based on the English context, the translators 51, 52 may translate “grupo” in the into “team” rather than “band”.

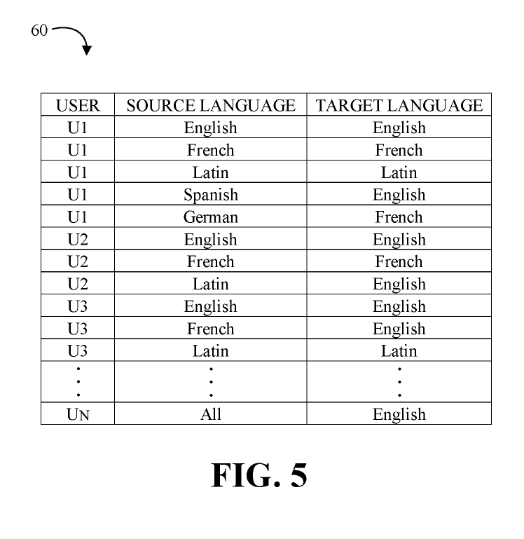

Turning now to FIG. 5, an example of a language preference database 60 is illustrated as a table. The language preference database 60 includes the language preferences of multiple users U1 through U_{N} with different preferences recorded for each user. The preferences may be self-identified (e.g. entered by each user through an appropriate user interface) or may be estimated based on contextual information available for the user. In the database 60, each user may have a set of source languages associated with a set of target languages such that when the language estimator 56 estimates an identification of a source language, the preferred target translation language may be retrieved from the database 60. For example, a monolingual user U_{N} may have all source languages translated into English while a multilingual user U1 may prefer to have Spanish translated into English and German translated into French.

Another embodiment of a database may include more extensive and/or complex associations to aid the language identification and/or translation process. For example, a user may have one or more associated language databases that identify what words or phrases the user knows in that language. Other words or phrases from that language may get translated. The translator may utilize the context of how many words or phrases the user knows in various languages to estimate a skill or fluency level of the user for a language. Another embodiment may include a user interface that shows or tells the user the original message together with the translation such that the user can learn more words or adjust the translation. For example, if the user knows that what the writer/speaker means by a particular word or phrase is different from a literal translation (e.g. an idiom, slang, or colloquial meaning), the user can teach the system alternate meanings or translations for future conversations. Similarly, if the system determines a low confidence level or identifies multiple possible translations, the system may show or tell the alternatives to the user and let the user select the most appropriate one (and/or let the user supply an alternate translation).

Although many of the examples above are given in the context of text messages, embodiments may additionally or alternatively be suitable for voice messages. For example, a speaker may compose a voice message by speaking into a microphone, after which the speech may be converted into an electronic representation of the voice message. For example, speech recognition may use natural language processing to pre-process a spoken phrase into a text message which may then be handled as described in the foregoing text-based examples. In addition, or alternatively, digitized speech may be processed directly without text conversion. On the recipient side, the known languages may play directly on a loudspeaker as recorded from the speaker while a synthesized voice output device may speak the translated portions (e.g. the translated portions may be converted from text back to speech as needed for playback on the loudspeaker).

For example, an embodiment of a mixed-language speech recognition system may include multiple language phonetic libraries for comparison to digitized speech to identify voice fragments from mixed-language voice messages. The language estimator may keep a record of which phonetic library matched the voice fragment to identify the language of the voice fragment. In addition, or alternatively, an embodiment of a mixed-language phonetic library may include phonetic words or phrases from more than one language. The mixed-language phonetic library may include language tags to identify a corresponding language for each phonetic match.

The various mixed-language communication systems, mixed-language translators, and other embodiments described herein may be utilized in real-time to support real-time mixed-language conversations (text-based or speech-based). In addition, or alternatively, the various mixed-language communication systems, mixed-language translators, and other embodiments described herein may also be utilized in an offline mode to convert a mixed-language message (e.g. including a text file or document) or a mixed-language audio recording to create a translated document or recording (e.g. based on the languages identified in the document or recording and the user's language preferences).

### ADDITIONAL NOTES AND EXAMPLES

Example 1 may include a mixed-language communication system, comprising a communication interface to send and receive electronic representations of messages between at least two users, a message composer to compose an electronic representation of a message, including a mixed-language message including a mix of at least two languages, and a mixed-language translator communicatively coupled to the communication interface and the message composer, the mixed-language translator including a language estimator to estimate two or more languages of at least two message fragments in one or more of a received mixed-language message from the communication interface or a composed mixed-language message from the message composer, a language preference detector to determine a language preference of one or more intended recipients, and a translator communicatively coupled to the language estimator and the language preference detector to translate one or more of the composed mixed-language message from the message composer or the received mixed-language message from the communication interface based on the estimated two or more languages of the at least two message fragments and the language preference of the one or more intended recipients.

Example 2 may include the mixed-language communication system of Example 1, wherein the language preference detector is further to determine a language preference of a composer of the composed mixed-language message, and wherein the language estimator is further to estimate the two or more languages of the at least two message fragments in one or more of the composed message or the received message based on one or more of the language preference of the composer or the language preference of the one or more intended recipients.

Example 3 may include the mixed-language communication system of Examples 1 or 2, wherein the language preference detector is further to determine the language preference of the one or more intended recipients based on stored information including one or more of a pre-identified language preference associated with one or more of the composer or the one or more intended recipients, a prior communication, a local file analysis, or a location indicator.

Example 4 may include a mixed-language translator apparatus, comprising a language estimator to estimate two or more languages of at least two message fragments in an electronic representation of a mixed-language message including at least two languages, a language preference detector to determine a language preference of an intended recipient for the mixed-language message, and a translator communicatively coupled to the language estimator and the language preference detector to translate the mixed-language message based on the estimated two or more languages of the at least two message fragments and the language preference of the intended recipient.

Example 5 may include the mixed-language translator apparatus of Example 4, wherein the language estimator is further to identify lingual boundaries in the mixed-language message.

Example 6 may include the mixed-language translator apparatus of Examples 4 to 5, wherein the language estimator is further to assign respective confidence levels to the estimated two or more languages of the at least two message fragments.

Example 7 may include the mixed-language translator apparatus of Example 6, wherein the language preference detector is further to determine a language preference of a composer of the mixed-language message and wherein the language estimator is further to assign the respective confidence levels based at least in part on one or more of the language preference of the composer or the language preference of the intended recipient.

Example 8 may include the mixed-language translator apparatus of Examples 4 to 7, wherein the language preference detector is further to determine the language preference of one or more of the intended recipient or the composer based on stored information including one or more of a pre-identified language preference associated with one or more of the composer or the intended recipient, a prior translation, a local file analysis, or a location indicator.

Example 9 may include the mixed-language translator apparatus of Examples 4 to 8, wherein the translator is further to translate the mixed-language message based at least in part on one or more of the assigned confidence levels, an idiomatic analysis, a semantic analysis, a contextual probability of an appropriate translation, or a language skill level of one or more of the composer or the intended recipient.

Example 10 may include the mixed-language translator apparatus of Examples 4 to 9, wherein the translator is further to translate the mixed-language message based at least in part on a language preference database associated with the intended recipient which maps source original languages to target translation languages.

Example 11 may include a method of mixed-language translation, comprising estimating two or more languages of at least two message fragments in an electronic representation of a mixed-language message including at least two languages, determining a language preference of an intended recipient for the mixed-language message, and translating the mixed-language message based on the estimated two or more languages of the at least two message fragments and the language preference of the intended recipient.

Example 12 may include the method of mixed-language translation of Example 11, further comprising identifying lingual boundaries in the mixed-language message.

Example 13 may include the method of mixed-language translation of Examples 11 to 12, further comprising assigning respective confidence levels to the estimated two or more languages of the at least two message fragments.

Example 14 may include the method of mixed-language translation of Example 13, further comprising determining a language preference of a composer of the mixed-language message, and assigning the respective confidence levels based at least in part on one or more of the language preference of the composer or the language preference of the intended recipient.

Example 15 may include the method of mixed-language translation of Examples 11 to 14, further comprising determining the language preference of one or more of the intended recipient or the composer based on stored information including one or more of a pre-identified language preference associated with one or more of the composer or the intended recipient, a prior translation, a local file analysis, or a location indicator.

Example 16 may include the method of mixed-language translation of Examples 11 to 15, further comprising translating the mixed-language message based at least in part on one or more of the assigned confidence levels, an idiomatic analysis, a semantic analysis, a contextual probability of an appropriate translation, or a language skill level of one or more of the composer or the intended recipient.

Example 17 may include the method of mixed-language translation of Examples 11 to 16, further comprising translating the mixed-language message based at least in part on a language preference database associated with the intended recipient which maps source original languages to target translation languages.

Example 18 may include at least one computer readable medium comprising a set of instructions, which when executed by a computing device, cause the computing device to estimate two or more languages of at least two message fragments in an electronic representation of a mixed-language message including at least two languages, determine a language preference of an intended recipient for the mixed-language message, and translate the mixed-language message based on the estimated two or more languages of the at least two message fragments and the language preference of the intended recipient.

Example 19 may include the at least one computer readable medium of Example 18, comprising a further set of instructions, which when executed by a computing device, cause the computing device to identify lingual boundaries in the mixed-language message.

Example 20 may include the at least one computer readable medium of Examples 18 to 19, comprising a further set of instructions, which when executed by a computing device, cause the computing device to assign respective confidence levels to the estimated two or more languages of the at least two message fragments.

Example 21 may include the at least one computer readable medium of Example 20, comprising a further set of instructions, which when executed by a computing device, cause the computing device to determine a language preference of a composer of the mixed-language message, and assign the respective confidence levels based at least in part on one or more of the language preference of the composer or the language preference of the intended recipient.

Example 22 may include the at least one computer readable medium of Examples 18 to 21, comprising a further set of instructions, which when executed by a computing device, cause the computing device to determine the language preference of one or more of the intended recipient or the composer based on stored information including one or more of a pre-identified language preference associated with one or more of the composer or the intended recipient, a prior translation, a local file analysis, or a location indicator.

Example 23 may include the at least one computer readable medium of Examples 18 to 22, comprising a further set of instructions, which when executed by a computing device, cause the computing device to translate the mixed-language message based at least in part on one or more of the assigned confidence levels, an idiomatic analysis, a semantic analysis, a contextual probability of an appropriate translation, or a language skill level of one or more of the composer or the intended recipient.

Example 24 may include the at least one computer readable medium of Examples 18 to 23, comprising a further set of instructions, which when executed by a computing device, cause the computing device to translate the mixed-language message based at least in part on a language preference database associated with the intended recipient which maps source original languages to target translation languages.

Example 25 may include a mixed-language translator apparatus, comprising means for estimating two or more languages of at least two message fragments in an electronic representation of a mixed-language message including at least two languages, means for determining a language preference of an intended recipient for the mixed-language message, and means for translating the mixed-language message based on the estimated two or more languages of the at least two message fragments and the language preference of the intended recipient.

Example 26 may include the mixed-language translator apparatus of Example 25, further comprising means for identifying lingual boundaries in the mixed-language message.

Example 27 may include the mixed-language translator apparatus of Examples 25 to 26, further comprising means for assigning respective confidence levels to the estimated two or more languages of the at least two message fragments.

Example 28 may include the mixed-language translator apparatus of Example 27, further comprising means for determining a language preference of a composer of the mixed-language message, and means for assigning the respective confidence levels based at least in part on one or more of the language preference of the composer or the language preference of the intended recipient.

Example 29 may include the mixed-language translator apparatus of Examples 25 to 28, further comprising means for determining the language preference of one or more of the intended recipient or the composer based on stored information including one or more of a pre-identified language preference associated with one or more of the composer or the intended recipient, a prior translation, a local file analysis, or a location indicator.

Example 30 may include the mixed-language translator apparatus of Examples 25 to 29, further comprising means for translating the mixed-language message based at least in part on one or more of the assigned confidence levels, an idiomatic analysis, a semantic analysis, a contextual probability of an appropriate translation, or a language skill level of one or more of the composer or the intended recipient.

Example 31 may include the mixed-language translator apparatus of Examples 25 to 30, further comprising means for translating the mixed-language message based at least in part on a language preference database associated with the intended recipient which maps source original languages to target translation languages.

Embodiments are applicable for use with all types of semiconductor integrated circuit (“IC”) chips. Examples of these IC chips include but are not limited to processors, controllers, chipset components, PLAs, memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the platform within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A mixed-language communication system, comprising:
a communication interface to send and receive electronic representations of messages between at least two users;
a message composer to compose an electronic representation of a message, including a mixed-language message including a mix of at least two languages; and
a mixed-language translator communicatively coupled to the communication interface and the message composer, the mixed-language translator including:
a language estimator to estimate two or more languages of at least two message fragments in one or more of a received mixed-language message from the communication interface or a composed mixed-language message from the message composer;
a language preference detector to determine a language preference of one or more intended recipients; and
a translator communicatively coupled to the language estimator and the language preference detector to translate one or more of the composed mixed-language message from the message composer or the received mixed-language message from the communication interface based on the estimated two or more languages of the at least two message fragments and the language preference of the one or more intended recipients.

2. The mixed-language communication system of claim 1, wherein the language preference detector is further to determine a language preference of a composer of the composed mixed-language message, and wherein the language estimator is further to estimate the two or more languages of the at least two message fragments in one or more of the composed message or the received message based on one or more of the language preference of the composer or the language preference of the one or more intended recipients.

3. The mixed-language communication system of claim 1, wherein the language preference detector is further to determine the language preference of the one or more intended recipients based on stored information including one or more of a pre-identified language preference associated with one or more of the composer or the one or more intended recipients, a prior communication, a local file analysis, or a location indicator.

4. A mixed-language translator apparatus, comprising:
a language estimator to estimate two or more languages of at least two message fragments in an electronic representation of a mixed-language message including at least two languages;
a language preference detector to determine a language preference of an intended recipient for the mixed-language message; and
a translator communicatively coupled to the language estimator and the language preference detector to translate the mixed-language message based on the estimated two or more languages of the at least two message fragments and the language preference of the intended recipient.

5. The mixed-language translator apparatus of claim 4, wherein the language estimator is further to identify lingual boundaries in the mixed-language message.

6. The mixed-language translator apparatus of claim 4, wherein the language estimator is further to assign respective confidence levels to the estimated two or more languages of the at least two message fragments.

7. The mixed-language translator apparatus of claim 6, wherein the language preference detector is further to determine a language preference of a composer of the mixed-language message and wherein the language estimator is further to assign the respective confidence levels based at least in part on one or more of the language preference of the composer or the language preference of the intended recipient.

8. The mixed-language translator apparatus of claim 4, wherein the language preference detector is further to determine the language preference of one or more of the intended recipient or a composer based on stored information including one or more of a pre-identified language preference associated with one or more of the composer or the intended recipient, a prior translation, a local file analysis, or a location indicator.

9. The mixed-language translator apparatus of claim 4, wherein the translator is further to translate the mixed-language message based at least in part on one or more of the assigned confidence levels, an idiomatic analysis, a semantic analysis, a contextual probability of an appropriate translation, or a language skill level of one or more of the composer or the intended recipient.

10. The mixed-language translator apparatus of claim 4, wherein the translator is further to translate the mixed-language message based at least in part on a language preference database associated with the intended recipient which maps source original languages to target translation languages.

11. A method of mixed-language translation, comprising:
estimating two or more languages of at least two message fragments in an electronic representation of a mixed-language message including at least two languages;
determining a language preference of an intended recipient for the mixed-language message; and
translating the mixed-language message based on the estimated two or more languages of the at least two message fragments and the language preference of the intended recipient.

12. The method of mixed-language translation of claim 11, further comprising:
identifying lingual boundaries in the mixed-language message.

13. The method of mixed-language translation of claim 11, further comprising:
assigning respective confidence levels to the estimated two or more languages of the at least two message fragments.

14. The method of mixed-language translation of claim 13, further comprising:
determining a language preference of a composer of the mixed-language message; and
assigning the respective confidence levels based at least in part on one or more of the language preference of the composer or the language preference of the intended recipient.

15. The method of mixed-language translation of claim 11, further comprising:
determining the language preference of one or more of the intended recipient or a composer based on stored information including one or more of a pre-identified language preference associated with one or more of the composer or the intended recipient, a prior translation, a local file analysis, or a location indicator.

16. The method of mixed-language translation of claim 11, further comprising:
translating the mixed-language message based at least in part on one or more of the assigned confidence levels, an idiomatic analysis, a semantic analysis, a contextual probability of an appropriate translation, or a language skill level of one or more of the composer or the intended recipient.

17. The method of mixed-language translation of claim 11, further comprising:
translating the mixed-language message based at least in part on a language preference database associated with the intended recipient which maps source original languages to target translation languages.

18. At least one computer readable medium comprising a set of instructions, which when executed by a computing device, cause the computing device to:
estimate two or more languages of at least two message fragments in an electronic representation of a mixed-language message including at least two languages;
determine a language preference of an intended recipient for the mixed-language message; and
translate the mixed-language message based on the estimated two or more languages of the at least two message fragments and the language preference of the intended recipient.

19. The at least one computer readable medium of claim 18, comprising a further set of instructions, which when executed by a computing device, cause the computing device to:
identify lingual boundaries in the mixed-language message.

20. The at least one computer readable medium of claim 18, comprising a further set of instructions, which when executed by a computing device, cause the computing device to:
assign respective confidence levels to the estimated two or more languages of the at least two message fragments.

21. The at least one computer readable medium of claim 20, comprising a further set of instructions, which when executed by a computing device, cause the computing device to:
determine a language preference of a composer of the mixed-language message; and
assign the respective confidence levels based at least in part on one or more of the language preference of the composer or the language preference of the intended recipient.

22. The at least one computer readable medium of claim 18, comprising a further set of instructions, which when executed by a computing device, cause the computing device to:
determine the language preference of one or more of the intended recipient or a composer based on stored information including one or more of a pre-identified language preference associated with one or more of the composer or the intended recipient, a prior translation, a local file analysis, or a location indicator.

23. The at least one computer readable medium of claim 18, comprising a further set of instructions, which when executed by a computing device, cause the computing device to:
translate the mixed-language message based at least in part on one or more of the assigned confidence levels, an idiomatic analysis, a semantic analysis, a contextual probability of an appropriate translation, or a language skill level of one or more of the composer or the intended recipient.

24. The at least one computer readable medium of claim 18, comprising a further set of instructions, which when executed by a computing device, cause the computing device to:
translate the mixed-language message based at least in part on a language preference database associated with the intended recipient which maps source original languages to target translation languages.
